(19) United States
(12) Patent Application Publication
(10) Pub. No.: US 2005/0166010 A1
(43) Pub. Date: Jul. 28, 2005

(54) Tape drive method and apparatus

(76) Inventor: Christopher Martin, Bath (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/015,866

(22) Filed: Dec. 20, 2004

(30) Foreign Application Priority Data
Dec. 20, 2003 (GB) 0329574.8

(51) Int. Cl. G06F 12/00

(52) U.S. Cl. 711/111; 713/2

(57) ABSTRACT

A sequential storage device and method for storing boot image data and for booting. Data, such as a tag or flag, indicative of boot image data is stored in non-volatile memory associated with the sequential storage medium. When the sequential storage medium is loaded the presence of the data is checked in order to determine whether boot image data is stored on the sequential storage medium or not. If boot image data is present, the sequential storage device starts emulation of an initial program load device.

### RELATED APPLICATIONS

The present application is based on, and claims priority from, GB Application Number 0329574.8, filed Dec. 20, 2003, the disclosure of which is hereby incorporated by reference herein in its entirety.

### FIELD OF THE INVENTION

The present invention relates to the field of data backup and recovery, and more particularly without limitation to tape drives.

### BACKGROUND

It is known to backup data stored on primary storage, such as a hard disk, of a computer system in order to protect against a disaster that might otherwise irrecoverably destroy all or part of the data. Disasters for example may be fire, flood, computer virus or simply accidental deletion of data. One of the main reasons for using magnetic tape as the backup storage medium is that it provides a stable, reliable and relatively cheap option for storing large volumes of backed-up data.

Backup application software which executes on the computer system typically provides the functions for enabling such computer system data to be both backed-up to, and restored from, tape media, which is written to and read from by a tape drive. Well-known backup application software includes ‘Replica™’ from Stac, ‘ArcServe™’ from Computer Associates, ‘BackupExec™’ from Veritas and ‘Data Protector™’ from HP. Well-known tape drives include DDS™ and LTO™ compliant tape drives, both available from HP.

In the event of a disaster, such as hard disk failure or even system destruction, typically, a priority is to rebuild a working system as soon as possible. This requires the computer hardware to be restored to the same state as it was before the disaster, which can take hours or even days, even before the file system can be restored. Generally, a significant amount of human intervention is required to complete this process.

In order to reduce the time and human intervention overhead of restoring a computer system after a disaster a backup application software provides a so-called disaster recovery (DR) solution, which enables a computer system to be restored in an expedited manner to a state which existed before a disaster occurred. Such a scheme typically involves at least installing and configuring a minimal operating system, tape drivers and the backup application software (or the requisite parts thereof) itself.

Known DR solutions typically require a user to generate a set of DR floppy disks. The DR floppy disks may be used to boot the computer system, when it is not possible to boot from the hard disk drive, and execute application software for recovering a backed-up copy of the file system from tape media. The DR floppy disks typically load and execute a minimal version of the operating system along with components of application software comprising DR functionality, thus providing sufficient functionality, for example, for the computer to build new disk partitions, access a tape drive and restore the data from tape media.

The DR operating system is required to reflect the exact hardware configuration of the computer system on which it is to be installed, otherwise it would not be possible to communicate with storage devices such as tape drives.

Typically, therefore, DR floppy disks need to be regenerated by a user whenever the system hardware configuration changes, and particularly when a SCSI (Small Computer Systems Interface) configuration changes. For example, if a new SCSI Host Bus Adaptor (HBA) is added to a server, with a respective new device driver, this device driver needs to be added to the DR floppy disks so that the new SCSI HBA is recognised when rebuilding the computer system.

A reason why DR floppy disks are used is that a floppy disk drive is one of the standard ‘initial program load devices’ (IPLD), which practically every PC is configured to ‘boot’ from. Herein, ‘standard’ as applied to an IPLD, implies that the PC is physically programed to recognise the device for the purposes of booting. Currently, other standard IPLDs, sometimes known as BAIDS (BIOS Aware Initial Program Load Devices), include the first hard disk drive in a PC and, more recently, the first CD-ROM drive in a PC. Generally, however, an IPLD can be virtually any device that has the ability to load and execute a PC operating system.

It is known to boot from a CD-ROM drive, as long as the CD-ROM complies with the ISO 9660 CD-ROM standard, as extended by the ‘El Torito’ Bootable CD-ROM Format Specification, Version 1.0, Jan. 25, 1995, created jointly by IBM Corporation and Phoenix Technologies Ltd.

The ‘El Torito’ bootable CD-ROM Format Specification provides the ability to catalogue boot images and to selectively boot from any single image stored on a CD-ROM. A BIOS with multiple boot-image capability can access any one of a number of bootable disc images listed in the booting catalogue stored on the CD-ROM. The boot-catalogue is a collection of 20 byte entries including a validation entry, an initial/default entry, a section entry, and section entry extension. The boot catalogue allows a computer system to pick a proper boot image and then to boot from the selected image.

Booting from CD-ROM in a similar manner is also considered in detail in U.S. Pat. No. 5,727,213. As described, to boot from CD-ROM, a PC's BIOS (basic input/output system) needs to specifically support reading boot record data from a CD-ROM, typically, as well as from a floppy disk or hard disk. U.S. Pat. No. 5,727,213 also proposes that tape media may also serve as a boot source, subject to the PC BIOS being modified to detect and read boot record data from a tape media. To date, however, PC BIOS standards do not support booting from tape media.

In a system which is bootable from a CD-ROM, U.S. Pat. No. 5,727,213 specifies that, to read boot record data from a CD-ROM, read commands directed to the floppy disk drive need to be re-directed to the CD-ROM drive during a read data part of the boot process. In addition, a modified SCSI driver of the PC needs to convert the 512 byte sectors conventionally used by hard disk and floppy disk into 2 Kbytes sectors conventionally used by a CD-ROM drive.

In view of the possibility of booting from CD-ROM, it would obviously also be possible to generate one or more DR CD-ROMs to replace the DR floppy disks. However, there would be little advantage in adopting this approach, and a significant cost increase. In particular, it would still be onerous for the user to have to generate, maintain and keep safe the DR CD-ROMs.

WO00/08561 the entirety of which is herein incorporated by reference shows a tape drive configured to operate as a bootable device for a PC. The tape drive has two modes of operation: the first mode in which it operates as a normal tape drive and the second in which it emulates a bootable CD-ROM drive.

Firmware provides both the normal mode of operation, in which the tape drive behaves as a tape drive, and the disaster recovery (DR) mode of operation, in which the tape drive is arranged to emulate a CD-ROM drive. The CD-ROM drive emulation is achieved in part by configuring the tape drive to identify itself to the PC as a CD-ROM drive. With the ability to emulate a CD-ROM drive, the tape drive can act as an ‘initial program load device’ (IPLD).

Whether the tape drive operates in normal mode or DR mode is determined by user selection. The user selection of mode may be performed without the need for any additional tape drive hardware by using the tape drive eject button; when the tape drive is powered on the eject button held down, the DR mode of operation is selected, otherwise the normal mode is selected.

This selection function is achieved by the tape drive's firmware that checks the status of the eject button during a power-on self-test sequence. Alternatively, DR mode can be selected by holding the eject button down for a long time period (such as 5 seconds), when the tape drive is already powered on, by the firmware which checks the length of the period the eject button is held down to determine whether the operation is an eject or the user selecting DR mode.

U.S. patent application publication No. 2002/00163760A1 shows a tape drive with control electronics adapted to determine that a tape cartridge is write-protected. In case the tape cartridge is write-protected the tape drive is configured as a bootable device in response to a disaster recovery request. This has the drawback that any write-protected tape cartridge is classified as containing bootable data even if this is not the case. Another disadvantage is that a disaster recovery request is required.

### SUMMARY OF THE INVENTION

The present invention provides for a sequential storage device and a method of storing boot image data using a sequential storage device, such as a tape drive. Boot image data that is received by the sequential storage device is transferred to a sequential storage medium. Further indicator data indicative that the data transferred to the sequential storage medium is boot image data is transferred to a non-volatile storage location.

In accordance with a preferred embodiment of the invention the sequential storage medium itself is used as the non-volatile memory for storing of the data indicative of the boot image data. Alternatively a cartridge memory of the sequential storage medium is used for storing the data indicative of the boot image data. Preferably the data indicative of the boot image data is stored in a predefined storage location of the non-volatile memory.

In accordance with a further preferred embodiment of the invention backup data is received from a computer, such as a media server computer or directly from the computer having a primary storage to be backed up. The sequential storage device makes a determination whether the backup data is boot image data or not. In case the backup data is in fact boot image data a corresponding tag or flag is stored in the predetermined storage location of the non-volatile memory.

In accordance with a further preferred embodiment of the invention the data indicative of the boot image data is stored in the non-volatile memory in response to an external command. For example the external command is sent from a backup application program in order to set the tag or flag on the predetermined storage location of the non-volatile memory.

Further the invention provides for a method of booting from a sequential storage device. The non-volatile memory of the sequential storage medium loaded in the sequential storage device is read in order to determine whether boot image data is stored on the sequential storage medium. If this is the case the sequential storage device starts emulating a bootable device.

This is particularly advantageous for the purpose of disaster recovery. In the case of disaster recovery it is no longer necessary to manually switch the sequential storage device into disaster recovery mode. Rather the sequential storage device starts emulating a bootable device when data indicative of the presence of boot image data on the sequential storage medium is detected. This has the advantage that the user does not need to be instructed to manually switch the tape drive apparatus into disaster recovery mode when a disaster recovery procedure is to be performed.

In accordance with a preferred embodiment of the invention a tape library comprises at least one tape drive apparatus of the invention. In a typical tape library the individual tape drives are often not conveniently accessible. In particular the eject button of a tape drive in a tape library may not be conveniently accessible by a user. The present invention is particularly advantageous in that it facilitates use of a tape drive as a bootable device without any manual intervention by a user in a tape library.

### BRIEF DESCRIPTION OF THE DRAWINGS

In the following a preferred embodiment of the invention will be described, by way of example only, and with reference to the drawings in which:

FIG. 1 is a schematic block diagram showing a tape drive coupled to a computer,

FIG. 2 is a flow diagram illustrating the steps involved in storing a boot image on tape media,

FIG. 3 is a flow diagram illustrating an alternative embodiment for storing a boot image on tape media,

FIG. 4 is a flow diagram illustrating the steps involved in booting from the tape drive.

### DETAILED DESCRIPTION

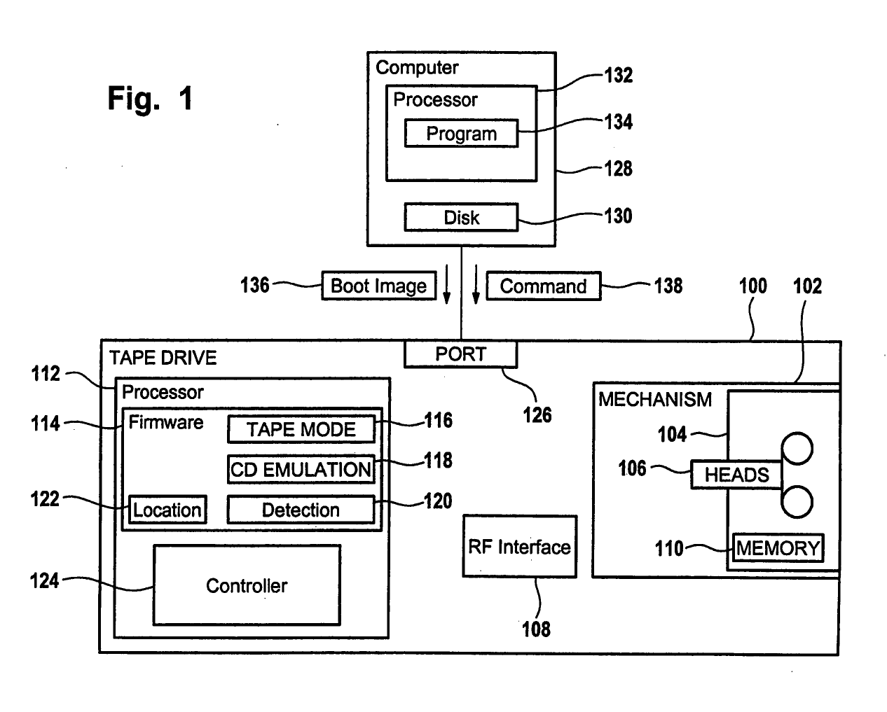

FIG. 1 shows tape drive 100 having tape mechanism 102 that loads and ejects tape media 104 and winds the tape media 104 forwards or backwards as required for reading and writing data. In an LTO (Linear Tape Open) tape drive, the tape is moved past the read/write heads 106 in a linear recording motion known as serpentine recording. Tape drive 100 has RF interface 108 that serves to communicate with cartridge memory 110 of tape media 104. Preferably RF interface 108 is compliant with the LTO specification.

Processor 112 of tape drive 100 serves to execute firmware 114. Firmware 114 comprises instructions 116 for providing the normal mode of operation in which the tape drive 100 behaves as a tape drive, and instructions 118 for emulation of a bootable device. Preferably instructions 118 provide an emulation of a CD-ROM drive in accordance with the ‘El Torito’ specification.

Further firmware 114 comprises instructions 120 for detecting of boot image data stored on tape media 104. A location indication 122 that identifies a predetermined storage location is also comprised in firmware 114. Depending on the implementation location indication 122 can be a offset in order to indicate a position on the tape media where the tag indicating the presence of boot image data is stored. Alternatively location indication 122 points to a storage location of cartridge memory 110.

Further processor 112 runs control program 124 that controls operation of tape drive 100. Tape drive 100 has port 126 for coupling of tape drive 100 to computer 128. Computer 128 has primary storage provided by disk 130 that requires backup. Further computer 128 has processor 132 that runs backup application program 134.

In operation tape media 104 is loaded into mechanism 102 of tape drive 100. Backup application program 134 reads data stored on disk 130 in order to provide boot image data 136 to tape drive 100. Tape drive 100 receives boot image data 136 at its port 126.

As tape drive 100 is in its default tape drive mode instructions 116 are executed which sequentially store boot image data 136 on tape media 104. Further backup application program 134 sends command 138 to tape drive 100 that is also received at port 126. In response to command 138 instructions 116 store a tag on the storage location as indicated by location indication 122.

This tag marks tape media 104 as containing boot image data. In case location indication 122 points to a location on the tape the tag is stored on this tape location. If location indication 122 points to a location of cartridge memory 110 the tag is stored in cartridge memory 110, in the case of LTO by means of RF interface 108.

As an alternative to command 138 instructions 116 examine the backup data received from backup application program 134 for the presence of boot image data 136. If boot image data 136 is identified in the data stream received from backup application program 134 the tag is stored on the location as indicated by location indication 122. In this instance it is not necessary that backup application program 134 sends command 138 as tape drive 100 itself makes a determination whether it receives normal backup data or boot image data from backup application program 134. In either case, as a result tape media 104 is obtained that stores boot image data 136.

In case the data stored on disk 130 of computer 128 is lost, e.g. due to a failure of disk 130, disk 130 is replaced by a new disk. In order to perform a disaster recovery operation tape media 104 with the stored boot image 136 is loaded into tape drive 100. Loading of tape media 104 invokes instructions 120 that read the memory location as defined by location indication 122.

This means that either the tape media 104 is read as at an offset position given by location indication 122 or a memory location of cartridge memory 110 is read by means of RF interface 108. As boot image data 136 has been stored on tape media 104 instructions 120 detect the corresponding tag.

As a consequence instructions 118 are invoked in order to start the CD-ROM emulation. Now tape drive 100 appears like a CD-ROM drive at its port 126. Next computer 128 is switched on. When computer 128 boots it checks its local disk 130 for the presence of a boot image. As disk 130 has been replaced no such bootable data is found. As a consequence computer 128 goes on and checks the emulated CD-ROM device at port 126 for the presence of a boot image. In response to the corresponding inquiry command the bootable data is read by tape drive 100 from tape media 104. The bootable data is output at port 126 by the CD-ROM emulation provided by instructions 118 such that computer 128 can boot from tape drive 100.

Preferably tape media 104 is compliant with the ULTRIUM LTO standard. Such tape cartridges are commercially available from Hewlett Packard. In this instance cartridge memory 110 is implemented as an intelligent memory chip embedded in the cartridge, referred to as the LTO-CM. It uses RF interface 108 that eliminates the need for a physical power or signal or connection between tape media 104 and tape drive 100. The LTO-CM is used for storing information which in other tape formats may be stored in the header at the beginning of the tape.

It is to be noted that computer 128 can be a media server computer. In this instance computer 128 receives backup data from other computers connected to it which computer 128 then provides as bootable data to tape drive 100.

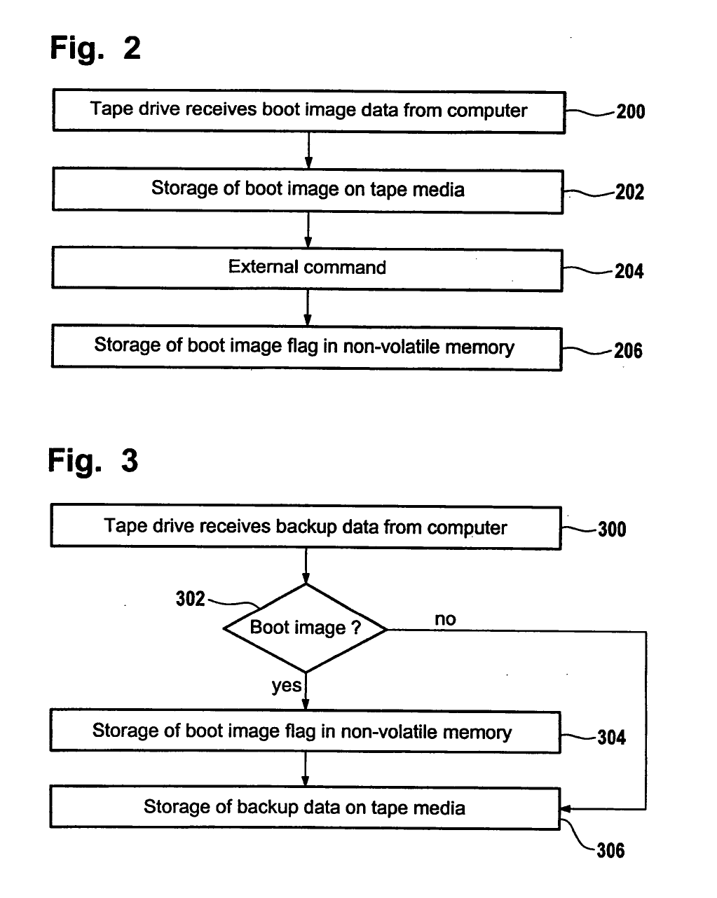

FIG. 2 shows a flowchart illustrating one method of operating tape drive 100 of FIG. 1. In step 200 the tape drive receives boot image data from a computer that is connected to it. In step 202 the boot image data is stored on tape media loaded into the tape drive. In step 204 the tape drive receives an external command from the computer. The external command indicates that boot image data has been provided in step 200. In response to the external command received in step 204 the tape drive stores a tag that indicates the presence of boot image data on the tape media. The tag is stored in non-volatile memory associated with the tape media, e.g. on the tape media itself or the cartridge memory of the tape media (step 206).

FIG. 3 shows an alternative method. In step 300 backup data is received by the tape drive. In step 302 the tape drive checks whether the backup data is normal backup data or boot image data. This determination can be performed based on the format of the received backup data. If the backup data is not boot image data the control goes to step 306 where the backup data is stored on the tape media. In case the backup data is in fact boot image data the control goes to step 304. In step 304 a tag is stored in non-volatile memory, e.g. on the tape media itself or the cartridge memory of the tape media. Next step 306 is performed in order to store the backup data containing the boot image data on the tape media.

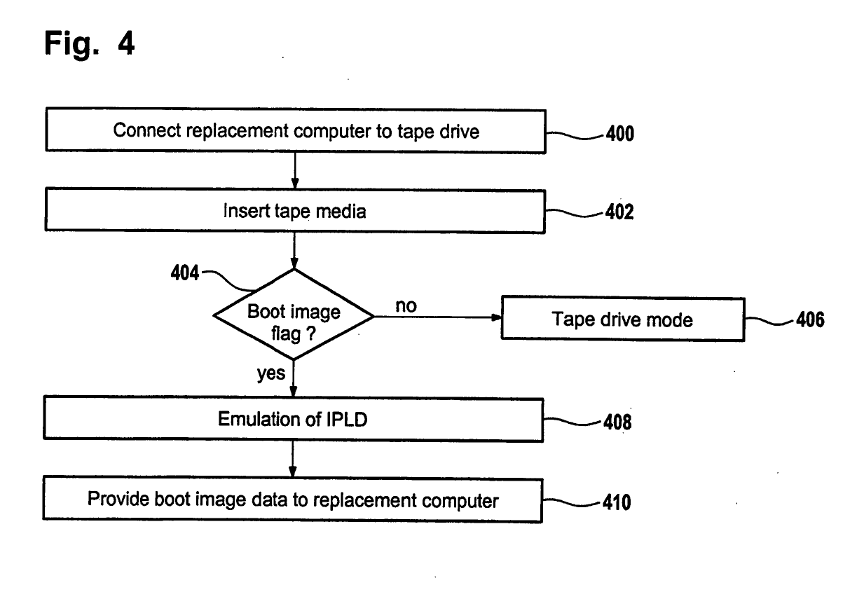

FIG. 4 illustrates a disaster recovery operation. For example a computer is lost or stolen and needs replacement. In step 400 the replacement computer is connected to the tape drive. In step 402 the tape media is loaded into the tape drive. The tape media stores the boot image that has been created in accordance with the methods of FIG. 2 or 3.

In step 404 the tape drive checks whether the boot image tag in the non-volatile memory is set or not. If the boot image tag is not set the tape drive continues to operate in its normal tape drive mode (step 406). However, in the case considered here the tape media does in fact contain boot image data and the boot image tag is thus set. As a consequence the tape drive starts emulation of an initial program load device (IPLD), such as a CD-ROM (step 408). This way the boot image data stored on the tape media is provided to the replacement computer in step 410 in order to perform the disaster recovery.

Reference Numerals

100 tape drive
102 tape mechanism
104 tape media
106 read/write heads
108 RF interface
110 cartridge memory
112 processor
114 firmware
116 instructions
118 instructions
120 instructions
122 location indication
124 control program
126 port
128 computer
130 disk
132 processor
134 backup application program
136 boot image data
138 command

1. A tape drive apparatus operable to
receive boot image data,
transfer the boot image data to a sequential storage medium,
transfer to a non-volatile storage location indicator data indicative that the data transferred to the sequential storage medium is boot image data.

2. The tape drive apparatus of claim 1, wherein the non-volatile storage location is on the sequential storage medium.

3. The tape drive apparatus of claim 1, wherein the non-volatile storage location is in a solid state memory associated with the sequential storage medium.

4. The tape drive apparatus of claim 1, wherein the indicator data is transferable using a wireless interface to the non-volatile storage location.

5. A method of storing boot image data, the method comprising:
receiving the boot image data,
transferring the boot image data to a sequential storage medium,
transferring to a non-volatile storage location indicator data indicative that the data transferred to the sequential storage medium is boot image data.

6. The method of claim 5, wherein the indicator data is stored in a predetermined storage location of the non-volatile storage location.

7. The method of claim 5, further comprising receiving backup data from a computer, and determining whether the backup data comprises the boot image data, wherein the indicator data is only stored in the non-volatile storage location in response to a determination being made that the backup data comprises the boot image data.

8. The method of claims 5, further comprising: receiving a command, wherein the indicator data is stored in the non-volatile memory in response to the command.

9. The method of claim 8, wherein the command is received from a computer that provides the boot image data.

10. The method of claim 1, when performed by a tape drive.

11. A storage device or medium carrying computer readable information for controlling a sequential storage device comprising instructions for:
receiving boot image data,
transferring the boot image data to a sequential storage medium,
transferring to a non-volatile storage location indicator data indicative that the data transferred to the sequential storage medium is boot image data.

12. The device or medium of claim 11 operable to read a location indication identifying a predetermined storage location of the non-volatile storage location for storage of the indicator data.

13. The device or medium of claim 10 operable to examine backup data received from an external computer for the presence of boot image data, wherein the indicator data is only stored in the non-volatile storage location in response to a determination being made that backup data comprises the boot image data.

14. The device or medium of claim 11, operable to receive and execute an external command in order to store the indicator data in the non-volatile storage location.

15. A method of booting from a sequential storage device comprising:
reading indicator data from a predetermined non-volatile storage location associated with a sequential storage medium,
using the indicator data to determine whether boot image data is stored on the sequential storage medium,
in response to a determination being made that boot image data is stored on the sequential storage medium, emulating a bootable device.

16. The method of claim 15, wherein the non-volatile storage location is on the sequential storage medium.

17. The method of claim 15, wherein the non-volatile storage location is a solid state memory associated with the sequential storage medium.

18. The method of claim 15, wherein a wireless interface is used for reading the predetermined non-volatile storage location.

19. The method of claim 15, wherein the sequential storage device is a tape drive.

20. The method of claim 15, wherein the emulated bootable device is an emulated optical storage device.

21. A storage device or medium carrying computer readable information for controlling a sequential storage device comprising instructions for:
reading a predetermined storage location of a non-volatile storage location of a sequential storage medium in order to determine whether boot image data is stored on the sequential storage medium,
in case boot image data is stored on the sequential storage medium, emulating a bootable device.

22. The device or medium of claim 21 operable to emulate an optical storage device.

23. A sequential storage device for transferring boot image data to a sequential storage medium comprising:
means for receiving the boot image data,
means for transferring the boot image data to the sequential storage medium,
means for transferring indicator data to a non-volatile storage location of the sequential storage medium.

24. The sequential storage device of claim 23, wherein the medium for transferring indicator data is operable to transfer the indicator data to a predetermined storage location of the non-volatile storage location.

25. The sequential storage device of claim 23, the means for transferring the indicator data being operable to transfer the indicator data to the sequential storage medium.

26. The sequential storage device of claims 23, the means for transferring the indicator data being operable to transfer the indicator data to a solid state memory associated with the sequential storage medium.

27. A tape drive apparatus comprising:
a data transfer apparatus for transferring bootable data between a loaded tape media and the tape drive apparatus,
tag transfer apparatus for transfer of a tag indicating bootable data to a non-volatile storage location associated with the tape media.

28. The tape drive apparatus of claim 27, the tag transfer apparatus being operable to transfer the indicator data to a predetermined storage location of the non-volatile storage location.

29. A sequential storage device comprising:
means for reading of bootable data from a loaded sequential storage medium,
means for reading a predetermined storage location of a non-volatile storage location in order to determine whether bootable data is stored on the sequential storage medium,
means for emulating a bootable device in response to a determination of a presence of bootable data stored on the sequential storage medium.

30. A tape drive apparatus comprising:
data transfer apparatus for transferring bootable data between a loaded tape media and the tape drive apparatus,
a component for reading a predetermined storage location of non-volatile storage location associated with the tape media in order to determine a presence of a tag indicative of bootable data stored on the tape media,
an emulation apparatus for emulating a bootable device in response to a detection of the tag.

31. The tape drive apparatus of claim 30, wherein the component for reading the predetermined storage location is provided by the data transfer apparatus.

32. The tape drive apparatus of claim 31, wherein the component for reading the predetermined storage location is adapted to read the tag from a cartridge memory.

33. A tape library having a plurality of tape drives, at least one of the tape drives comprising:
a data transfer apparatus for transferring bootable data between a loaded tape media and the tape drive apparatus,
a component for reading a predetermined storage location of non-volatile storage location associated with the tape media in order to determine the presence of a tag indicative of bootable data stored on the tape media,
an emulation apparatus for emulating a bootable device in response to a detection of the tag.

34. A non-volatile memory component comprising firmware for controlling a tape drive, the firmware comprising instructions for:
receiving boot image data,
causing the boot image data to be transferred to tape media,
causing indicator data to be transferred to a non-volatile memory.

35. A non-volatile memory component comprising firmware for controlling a tape drive, the firmware comprising instructions for:
reading a predetermined storage location of a non-volatile memory of tape media loaded by the tape drive in order to determine whether boot image data is stored on the tape media,
in response to determining that boot image data is stored on the tape media, emulating a bootable device.
